(19) United States
(12) Patent Application Publication
(10) Pub. No.: US 2022/0200995 A1
(43) Pub. Date: Jun. 23, 2022

(54) METHOD AND SERVER FOR ACCESS VERIFICATION IN AN IDENTITY AND ACCESS MANAGEMENT SYSTEM

(71) Applicant: ELEMENT AI INC., Montré, Québec (CA)

(72) Inventors: Louis Philip MORIN, Montré, Québec (CA); Benoit HAMELIN, Montré, Québec (CA); Fanny LALONDE LÉVESQUE, Montré, Québec (CA); Nicolas BIGAOUETTE, Montré, Québec (CA); Frédéric MICHAUD, Montré, Québec (CA); Éric GINGRAS, Montré, Québec (CA)

(21) Appl. No.: 17/252,662

(22) PCT Filed: Jun. 18, 2019
(86) PCT No.: PCT/IB2019/055106

§ 371 Date: Dec. 15, 2020

Related U.S. Application Data
(60) Provisional application No. 62/686,181, filed on Jun. 18, 2018.

(51) Int. Cl. H04L 9/40

(52) U.S. Cl. CPC H04L 63/101; H04L 63/102; H04L 63/104; H04L 63/105

(57) ABSTRACT

A method for access verification in an IAM system, comprising: receiving a role and a group of users associated with the role, the role comprising a list of role entitlements indicative of given permissions to execute first actions by each user of the group of users; for each one of the at least a portion of the group of users, retrieving a respective list of user entitlements indicative of actual permissions to execute second actions, the actual permissions having been granted to a respective user; for each one of the at least portion of the group of users, comparing the respective list of user entitlements to the list of role entitlements; and outputting an identification of a given user of the at least portion of the group of users in response to the respective list of user entitlements exceeding the list of role entitlements for the given user:

### TECHNICAL FIELD

The present technology relates to the field of Identity and Access Management (IAM), and more particularly to methods and servers for verifying accesses in applications through an IAM system.

### BACKGROUND

In IAM, a role is an aggregation of entitlements, privileges or access rights that allow authentication and authorization to perform at least one specific action in an application, system or site. The roles thus constructed are then assigned to users to give them all associated accesses in a single act of association instead of having to grant each individual access one by one. Roles may also have an associated rule, based on human resources (HR) attribute values, that define groups of users who automatically receive the role and who lose the role when they no longer fit the rule. This access granting model, called Role Based Access Control (RBAC) allows for operationalization of complex access control models, which can then be used to automate large parts of access provisioning and deprovisioning. They are useful when they can streamline the granting of large amounts of accesses because of a large number of accesses a specific role requires, because they are used by a large number of identities, or because there is a high employee turnover in a job that can be covered by a role, for example.

In IAM, access certification or access attestation is the process of validating entitlements. This process is generally executed at least once a year by employee managers who have to formally confirm (or attest) for each entitlement assigned to an employee if the employee really needs the entitlement as part of his/her function. Indeed, even if two employees are assigned a same role, one employee may have additional entitlements in comparison to the other employee. The target of the access certification is to determine whether the employee should keep the additional entitlements or not.

This process is often presented as mandatory for compliance and security risk management. However, this process can quickly become arduous for organizations with dispersed systems, workforce, and/or partners.

Due to the fragmented nature of employees who frequently use multiple entitlements in multiple applications, it can become tiresome to look at each and every single element. Due to the sheer amount of data to be parsed by a human, the certification process is usually used to target only very specific applications or accesses, thereby leaving other applications and accesses at risk of abuse or misappropriation.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

Embodiments of the present technology have been developed based on developers' appreciation that organizations having numerous employees, client devices associated with the employees, as well as a variety of electronic resources accessible by the employees via their respective client devices can be difficult to manage regarding entitlements, privileges and authorization access rights.

Further, due to factors such as employee turnover, employee changing positions in the organization, and the emergence of new positions and applications, and application access rights may become harder to manage. In some instances, employees or members of an organization may have access rights exceeding the access rights intended by the management of the organization, which could be problematic as an example if a member has malevolent intentions, or if an electronic device is infected by malware that could exploit the exceeding access rights.

Management of the access rights as envisioned in the context of the present technology improves security of the computer system and resources hosted by the computer system, which can in turn prevent problems, such as creation of large digital files, spam or unauthorized use of files, thereby saving computational resources and bandwidth.

Thus, embodiments of the present technology are directed to methods and servers for access verification in an identity and access management (IAM) system.

According to a first broad aspect, there is provided a computer-implemented method for access verification in an identity and access management (IAM) system, the method being executable by a server, the method comprising: receiving a role and a group of users associated with the role, the role comprising a list of role entitlements, the list of role entitlements being indicative of given permissions to execute first actions in at least one electronic resource by each user of the group of users; for each one of the at least a portion of the group of users, retrieving a respective list of user entitlements, the list of user entitlements being indicative of actual permissions to execute second actions in the at least one electronic resource, the actual permissions having been granted to a respective user; for each one of the at least portion of the group of users, comparing the respective list of user entitlements to the list of role entitlements; and retrieving and outputting an identification of a given user of the at least portion of the group of users in response to the respective list of user entitlements exceeding the list of role entitlements for the given user:

In one embodiment, the respective list of user entitlements associated with the given user exceeding the list of role entitlements is indicative of at least one potential excess user entitlement.

In one embodiment, the computer-implemented method further comprises: retrieving, based on the identification of the given user, usage data for the given user, the usage data being indicative of actions having been executed by the given user; determining, based on the potential excess user entitlement, excess actions executed by the given user in the usage data while using the potential excess user entitlement; and outputting the determined excess actions.

In one embodiment, the computer-implemented method further comprises generating the role and determining the group of users associated with the role.

In one embodiment, said generating the role is performed using at least one of top-down role mining method, a by-example method, a visual-based method and a bottom-up role mining method.

In one embodiment, the bottom-up role mining method comprises: receiving access usage data comprising identities and respective performed actions; receiving a list of access entitlements each allowing the execution of at least one respective action; generating a plurality of groups of actions by regrouping given ones of the identities having associated thereto a same group of the respective performed actions using the access usage data; for each one of the plurality of groups of actions, determining a group of entitlements contained in the list of access entitlements that allow the execution of the group of actions; for each one of the plurality of groups of actions, associating thereto the respective group of entitlements, thereby obtaining a plurality of roles; and outputting the plurality of roles.

In one embodiment, said receiving access usage data comprises receiving an account identification (ID) for the given user and the excess actions.

In one embodiment, the computer-implemented method further comprises receiving application data comprising actual entitlements associated with the account ID.

In one embodiment, said receiving the list of access entitlements comprises generating a map of entitlements by mapping the access entitlements to the performed actions using the access usage data and the application data.

In one embodiment, said mapping the access entitlements to the performed actions is performed by solving a linear program in binary variables.

In one embodiment, the computer-implemented method further comprises receiving attribute data comprising the user ID and human resources and business attributes.

In one embodiment, the computer-implemented method further comprises mapping the account ID to the user ID.

In one embodiment, generating the plurality of groups of actions is performed using further the attribute data.

In one embodiment, said generating the plurality of groups of actions is performed using at least one of a clustering method, a matrix decomposition method, a topic modeling method and a frequent itemset method to obtain a probabilistic assignment of actions to the groups of actions.

In one embodiment, the clustering method comprises one of a density-based spatial clustering of applications with noise (DBSCAN) method, a K-means method and a hierarchical clustering method.

In one embodiment, the topic modeling method comprises one of a latent dirichlet allocation (LDA) method and a hierarchical dirichlet process (HDP) method.

In one embodiment, the frequent itemset method comprises an Apriori method.

In one embodiment, the computer-implemented method further comprises using a discretization procedure to convert the probabilistic assignment of actions to the groups of actions to an actual assignment of actions to the groups of actions.

In one embodiment, the computer-implemented method further comprises assigning at least one of the human resources and business attributes to each one of the groups of actions, thereby obtaining an assignment of attributes for each group of actions.

In one embodiment, said determining a group of entitlements is performed using the application data, the actual assignment of actions to the groups of actions and the assignment of attributes for each group of actions.

According to a second broad aspect, there is provided a computer program product comprising a non-volatile computer readable memory storing computer executable instructions thereon that when executed by a computer perform the steps of the above-described computer-implemented method.

According to a third broad aspect, there is provided a system comprising a processor, a communication interface and a memory having stored thereon executable instructions that when executed by the processor perform the steps of the above-described computer-implemented method.

According to another broad aspect, there is provided a server for access verification in an Identity and Access Management (IAM) system, the server comprising: a processor; communication means for at least one of receiving and transmitting data; and a memory operatively connected to the processor, the memory comprising computer-readable instructions stored thereon; the processor, upon execution of the computer-readable instructions, being configured for: receiving a role and a group of users associated with the role, the role comprising a list of role entitlements, the list of role entitlements being indicative of given permissions to execute first actions in at least one electronic resource by each user of the group of users; for each one of the at least a portion of the group of users, retrieving a respective list of user entitlements, the list of user entitlements being indicative of actual permissions to execute second actions in the at least one electronic resource, the actual permissions having been granted to a respective user; for each one of the at least portion of the group of users, comparing the respective list of user entitlements to the list of role entitlements; and retrieving and outputting an identification of a given user of the at least portion of the group of users in response to the respective list of user entitlements exceeding the list of role entitlements for the given user:

In one embodiment, the respective list of user entitlements associated with the given user exceeding the list of role entitlements is indicative of at least one potential excess entitlement.

In one embodiment, the processor is further configured for: retrieving, based on the identification of the given user, usage data for the given user, the usage data being indicative of actions having been executed by the given user; determining, based on the potential excess user entitlement, excess actions executed by the given user in the usage data while using the potential excess user entitlement; and outputting the determined excess actions.

In one embodiment, the processor is further configured for generating the role and determining the group of users associated with the role.

In one embodiment, the processor is configured for generating the role based on at least one of top-down role mining method, a by-example method, a visual-based method and a bottom-up role mining method.

In one embodiment, the processor is configured for using the bottom-up role mining technique, the processor being configured for: receiving access usage data comprising identities and respective performed actions; receiving a list of access entitlements each allowing the execution of at least one respective action; generating a plurality of groups of actions by regrouping given ones of the identities having associated thereto a same group of the respective performed actions using the access usage data; for each one of the plurality of groups of actions, determining a group of entitlements contained in the list of access entitlements that allow the execution of the group of actions; for each one of the plurality of groups of actions, associating thereto the respective group of entitlements, thereby obtaining a plurality of roles; and outputting the plurality of roles.

In one embodiment, the access usage data comprises an account identification (ID) for the given user and the excess actions.

In one embodiment, the processor is further configured for receiving application data comprising actual entitlements associated with the account ID.

In one embodiment, the processor is further configured for generating a map of entitlements by mapping the access entitlements to the performed actions using the access usage data and the application data.

In one embodiment, the processor is further configured for mapping the access entitlements to the performed actions by solving a linear program in binary variables.

In one embodiment, the processor is further configured for receiving attribute data comprising the user ID and human resources and business attributes.

In one embodiment, the processor is further configured is to map the account ID to the user ID.

In one embodiment, the processor is further configured for generating the plurality of groups of actions further using the attribute data.

In one embodiment, the processor is further configured for generating the plurality of groups of actions using at least one of a clustering method, a matrix decomposition method, a topic modeling method and a frequent itemset method to obtain a probabilistic assignment of actions to the groups of actions.

In one embodiment, the clustering method comprises one of a density-based spatial clustering of applications with noise (DBSCAN) method, a K-means method and a hierarchical clustering method.

In one embodiment, the topic modeling method comprises one of a latent dirichlet allocation (LDA) method and a hierarchical dirichlet process (HDP) method.

In one embodiment, the frequent itemset method comprises an Apriori method.

In one embodiment, the processor is further configured for using a discretization procedure to convert the probabilistic assignment of actions to the groups of actions to an actual assignment of actions to the groups of actions.

In one embodiment, the processor is further configured for assigning at least one of the respective human resources and business attributes to each one of the groups of actions, thereby obtaining an assignment of attributes for each group of actions.

In one embodiment, the processor is further configured for determining the group of entitlements using the application data, the actual assignment of actions to the groups of actions and the assignment of attributes for each group of actions.

It should be understood that the entitlements may also include privileges, access rights, and/or the like.

### Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Further features and advantages of the present invention will become apparent from the following detailed description, taken in combination with the appended drawings, in which:

FIG. 1 is a schematic diagram of an electronic device suitable for use with some non-limiting embodiments of the present technology.

FIG. 2 is a schematic diagram of a networked system in accordance with non-limiting embodiments of the present technology.

FIG. 3 is a schematic diagram of an IAM controller being executable within the system of FIG. 2 in accordance with non-limiting embodiments of the present technology;

FIG. 4 is a schematic diagram of a first role generator for creating roles for an IAM system, the role generator being executable within the system of FIG. 2.

FIG. 5 is a schematic diagram of a second role generator for creating roles for an IAM system, the role generator being executable within the system of FIG. 2.

FIG. 6 is a block diagram of a computer-implemented method for identifying users who may be provided with excess entitlements, the method being executable within the networked system of FIG. 2 in accordance with non-limiting embodiments of the present technology.

FIG. 7 illustrates a block diagram of a first computer-implemented method for defining roles in an IAM system, the method being executable within the networked system of FIG. 2 in accordance with non-limiting embodiments of the present technology.

FIG. 8 illustrates a block diagram of a second computer-implemented method 800 for creating roles in an IAM system, the method being executable within the networked system of FIG. 2 in accordance with non-limiting embodiments of the present technology

It will be noted that throughout the appended drawings, like features are identified by like reference numerals.

### DETAILED DESCRIPTION

In the following, there is described a method and system for identifying unnecessary or suspect entitlements assigned to users in order to help a person such as a manager to take decisions regarding access certification. Some users such as some employees may be provided with entitlements that they should not have or they do not use/need. Such entitlements may be seen as unnecessary entitlements which may present a risk of abuse or misappropriation. The purpose of the present method and system is to identify users being provided with unnecessary or suspect entitlements.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one non-limiting embodiment, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

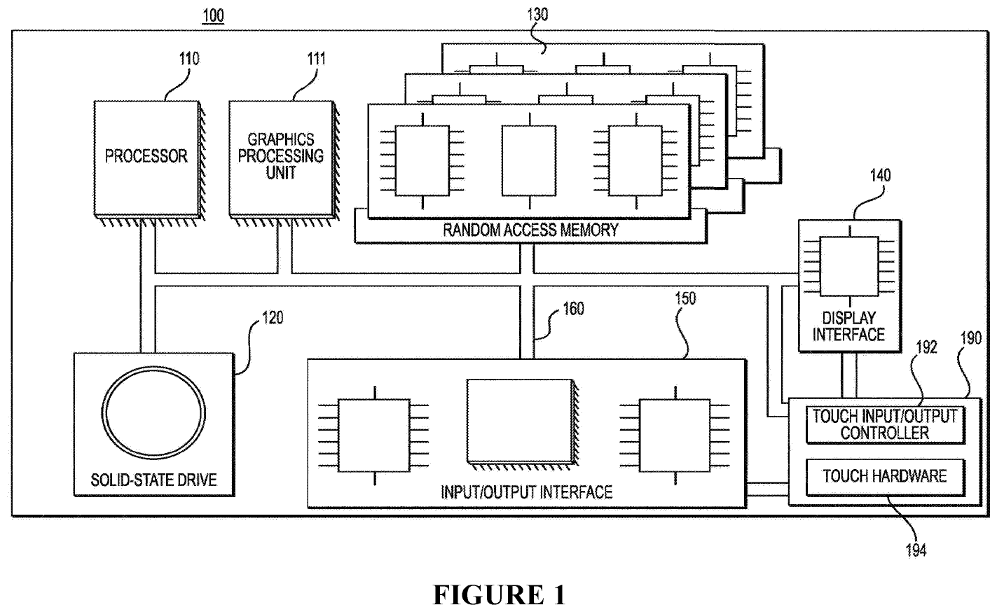

With reference to FIG. 1, there is depicted a schematic diagram of an electronic device 100 suitable for use with some non-limiting embodiments of the present technology.

Electronic Device

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

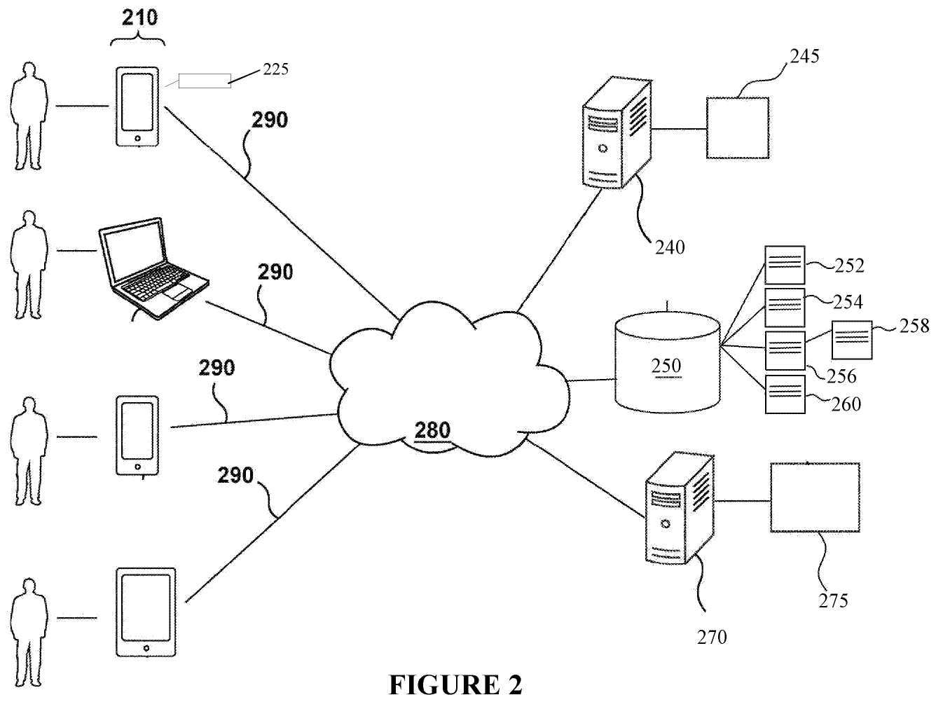

Now turning to FIG. 2, there is depicted a schematic diagram of a networked system 200, the networked system 200 being suitable for implementing non-limiting embodiments of the present technology. It is to be expressly understood that the networked system 200 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the networked system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the networked system 200 may provide in certain instances simple implementations of the present technology, and that where such is the case they have been presented in this manner as an aid to understanding. As persons skilled in the art would understand, various implementations of the present technology may be of a greater complexity.

Networked System

The networked system 200 comprises a plurality of client devices 210, a first server 240, a database 250, and an IAM server 260 coupled to a communications network 280 via respective communication links 290 (only one numbered in FIG. 1).

Plurality of Client Devices

Each of the plurality of client devices 210 is communicatively coupled to the communications network 280 via the respective communication link X. The implementation of each of the plurality of client devices 210 is not particularly limited, but as an example, a given one of the plurality of client devices 210 may be implemented as a personal computer (desktops, laptops, netbooks, etc.), a wireless communication device (such as a smartphone, a cell phone, a tablet and the like), as well as network equipment (such as routers, switches, and gateways). Each of the plurality of client devices 210 may have some or all of the components of the electronic device 100.

Each of the plurality of client devices 210 comprises hardware and/or software and/or firmware (or a combination thereof), as is known in the art, to execute one or more applications 225 to access one or more electronic resources 245 provided by and/or hosted by the first server 240.

Generally speaking, a given client device of the plurality of client devices 210 is associated with a user (not depicted in FIG. 2). It should be noted that the fact that the plurality of client devices 210 are associated with a user does not need to suggest or imply any mode of operation—such as a need to log in, a need to be registered, or the like. The user may access the one or more application 225 on a respective client device of the plurality of client devices 210, and execute actions therein.

It is contemplated that any number of client devices could be connected to the communications network 280 of the networked system 200. It is further contemplated that in some implementations, the number of the plurality of client devices 210 included in the networked system 200 could number in the tens or hundreds of thousands.

How the respective communication links 290 are implemented is not particularly limited and will depend on how each of the plurality of client devices 210 implemented. Merely as an example and not as a limitation, in those embodiments of the present technology where a given one of the plurality of client devices 210 is implemented as a wireless communication device (such as a smartphone), the respective communication link 290 can be implemented as a wireless communication link (such as but not limited to, a 3G communication network link, a 4G communication network link, Wireless Fidelity, or WiFi® for short, Bluetooth® and the like). In those examples where the given one of the plurality of client devices 210 is implemented as a notebook computer, the communication link can be either wireless (such as Wireless Fidelity, or WiFi® for short, Bluetooth® or the like) or wired (such as an Ethernet based connection).

In one non-limiting embodiment, the communications network 280 can be implemented as the Internet. In other embodiments of the present technology, the communications network 280 can be implemented differently, such as any wide-area communications network, local-area communications network, a private communications network and the like.

First Server

Generally speaking, the first server 240 is configured to: (i) host one or more electronic resources 245 accessible via the plurality of client devices 210; and (ii) store actions executed by the plurality of client devices 210 on the one or more electronic resources 245.

The first server 240 can be implemented as a conventional computer server and may comprise some or all of the features of the electronic device 100 depicted in FIG. 1. In an example of an embodiment of the present technology, the first server 240 can be implemented as a Dell™ PowerEdge™ Server running the Microsoft™ Windows Server™ operating system. Needless to say, the first server 240 can be implemented in any other suitable hardware and/or software and/or firmware or a combination thereof. In the depicted non-limiting embodiment of present technology, the first server 240 is a single server. In alternative non-limiting embodiments of the present technology, the functionality of the first server 240 may be distributed and may be implemented via multiple servers (not depicted). As a non-limiting example, the first server 240 may be a plurality of servers (not depicted), each of the plurality of servers hosting one or more respective resources accessible by users via the plurality of client devices 210.

An electronic resource can be anything that is possible to address with a uniform resource locator (URL). An electronic resource can include a web page, software application, file, database, directory, data unit, etc. In one non-limiting embodiment, an electronic resource is anything accessible to a user of one of the plurality of electronic devices 210 on the communications network 280. As a non-limiting example, the one or more electronic resources 245 may include: emails in an email service, files in a file storage service, media files (text, images, videos, etc.) in a media content sharing service, and the like

The one or more electronic resources 245 are accessible via the one or more applications 220.

Database

The networked system 200 comprises a database 250 coupled to the communications network 280. In alternative embodiments, the database 250 may be coupled to the first server 240 and/or the IAM server 270 without departing from the teachings of the present technology. Although the database 250 is illustrated schematically herein as a single entity, it is contemplated that the database 250 may be configured in a distributed manner, for example, the database 250 could have different components, each component being configured for a particular kind of retrieval therefrom or storage therein.

The database 250 may be a structured collection of data, irrespective of its particular structure or the computer hardware on which data is stored, implemented or otherwise rendered available for use. The database 250 may reside on the same hardware as a process that stores or makes use of the information stored in the database 250 or it may reside on separate hardware, such as on the first server 240. Generally speaking, in the context of the present technology, the database 250 may receive data from the first server 240 for storage thereof and may provide stored data to the IAM server 270 for use thereof.

In one non-limiting embodiment, the first server 240 is configured to store, in the database 250, inter alia user data, user entitlement data, role data, and access data.

It should be understood that in one non-limiting embodiment, the database 250 may be accessible by other electronic devices (not depicted) connected to the communications network 280.

As a non-limiting example, human resources of an organization may store some or part of employee attribute data in the database 250.

User Data

The database 250 stores user data 252, the user data 252 including information about each user of the one or more electronic resources 245, such as users (not depicted) associated with each of the plurality of client devices 210.

The user data 252 may comprise one or more of: account, account identifier (ID), first name, last name, location information, email, address, client device identifier, etc.

In one non-limiting embodiment, the user data 252 may be divided user data originating from the organization or business he is a port of, and user data related to the one or more electronic resources 245. It should be noted that in this case the data may be stored in separate databases.

The user data 252 may comprise attribute data such as HR attributes and/or business attributes that may help identify a user's function within an organization. For example, the attribute data may comprise a title, a level, a manager's ID, employee number, department an organization unit, a status, and/or the like.

User Entitlement Data

The database 250 stores user entitlement data, in the form of a respective list of user entitlements 254 for each user of the one or more electronic resources 245.

Generally speaking, the respective list of user entitlements 254 is indicative of permissions to execute actions via a respective client device of the plurality of client devices 210 having been granted to each user when the user was created in the one or more electronic resources 245.

The respective list of user entitlements 254 includes various access rights and authorizations, such as, but not limited to: read, write, edit, create, delete files on each of the one or more electronic resources 245 provided by the first server 240.

As a non-limiting example, one or more entitlements in the respective list of user entitlements 254 may have been determined by an operator when a user has been added to a position in a company, and/or by an operator of the electronic resource.

Role Data

The database 250 stores role data, the role data including roles 256, where each role includes a respective list of entitlements 258, hereinafter referred to as role entitlements, and respective group of users associated with the role.

In one non-limiting embodiment, each of the roles may correspond to roles in a business or organization, the roles having been defined by operator.

Generally speaking, the respective list of role entitlements is indicative of permissions to execute actions in at least one electronic resource by each respective user associated with the role. The respective list of role entitlements 258 may include various access rights and authorizations, such as, but not limited to: read, write, edit, create, delete files on each of the one or more electronic resources 245 provided by the first server 240.

In the context of the present technology, the roles 256 may have been defined by one or more operator(s), by one or more machine learning algorithm (MLA), or a combination thereof.

It should be understood that two different roles may have similar role entitlements.

Each role is associated with a respective group of users (not depicted). The respective group of users may include one or more users associated with the role and having access to the one or more electronic resources 245 via respective ones of the plurality of client devices 210. In one non-limiting embodiment, each role is associated with a group of users identified by account IDs.

Access Usage Data

In one non-limiting embodiment, the database 250 stores access usage data 260 tracked by the first server 240.

The access usage data 260 corresponds to actions performed by users on the one or more electronic resources 245 of the first server 240.

A number and type of the usage data is not limited, and may include all activities and actions performed by a user associated with a client device X, or a subset of all activities and actions performed by user(s) over a given period of time. As a non-limiting example, the access usage data may include: electronic resources accessed by a user, physical resources accessed by a user, files opened, created, modified, and deleted by a user, physical locations accessed by a user, devices used by a user, etc.

The manner in which the usage data information is stored is not limited, and may as a non-limiting example be divided by type of actions, type of service, and the like.

In one non-limiting embodiment, the access usage data is stored for each account ID.

Identity and Access Management Server

Generally speaking, the IAM server 270 is configured to execute an IAM system. To achieve that purpose, the IAM server 270 is configured to: (i) retrieve one or more roles, the role including role entitlements; (ii) retrieve respective group of users associated with the one or more roles; (ii) retrieve respective user entitlements associated with a given user of the respective group of users; (iii) retrieve user usage data associated with the given user; (iv) compare user entitlements associated with the given user and role entitlements; and (v) output a result of the comparison.

In one non-limiting embodiment, the IAM server 270 is further configured to execute IAM role creation. To achieve that purpose the IAM server 270 is configured to: (i) retrieve one or more of usage access data, user attribute data, and application data; (ii) analyze and map user entitlement data; (iii) determine groups of users based on the mapped data; and (iv) generate roles based on the determined group of users.

The IAM server 270 can be implemented as a conventional computer server and may comprise some or all of the features of the electronic device 100 depicted in FIG. 1. In an example of an embodiment of the present technology, the IAM server 270 can be implemented as a Dell™ PowerEdge™ Server running the Microsoft™ Windows Server™ operating system. Needless to say, the IAM server 270 can be implemented in any other suitable hardware and/or software and/or firmware or a combination thereof. In the depicted non-limiting embodiment of present technology, the IAM server 270 is a single server. In alternative non-limiting embodiments of the present technology, the functionality of the IAM server 270 may be distributed and may be implemented via multiple servers (not depicted).

The IAM server 270 may have access to one or more databases (not depicted) to store information therein. In one non-limiting embodiment, the IAM server 270 has access to one or more machine learning algorithms (MLA) 275 for performing IAM verification and IAM role generation.

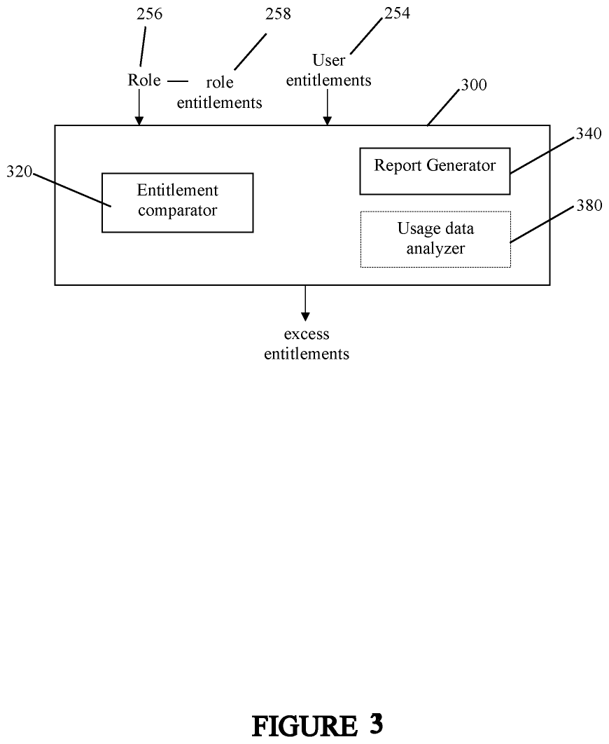

How the IAM server 270 is configured to execute IAM verification and IAM role creation will now be explained with reference to FIGS. 3 to 5.

IAM Controller

FIG. 3 illustrates a schematic diagram of a IAM controller 300 for identifying users who may be provided with excess entitlements in accordance with non-limiting embodiments of the present technology.

The IAM controller 300 is executed by the IAM server 260. It should be noted that the IAM controller 300 may be executed by more than one server (not depicted) and/or executed in a distributed manner.

Generally speaking, the purpose of the IAM controller 300 is to identify users associated with the one or more electronic resources 245 of the server 240 having entitlements in the respective list of user entitlements that differ from the entitlements in the role entitlements associated with their role. The excess entitlements may indicate that identified users have actual permissions to execute action on the or more electronic resources 245 that the user should not have. Such excess entitlements may have been mistakenly attributed and may be unnecessary to the identified users.

The IAM controller 300 may be executed at predetermined periods of time, or may be executed upon receiving an indication. As a non-limiting example, the IAM controller 300 may be executed upon receiving one or more roles from the server 240.

The IAM controller 300 comprises a entitlement comparator 320 and a report generator 340.

The entitlement comparator 320 is configured for receiving a role 256, the role including a list of role entitlements 258. The entitlement comparator 320 may receive the role including the list of role entitlements 258 from the database 250. In other non-limiting embodiments of the present technology, the entitlement comparator 320 may receive the role 256 from another database or another electronic device connected to the server 258.

The entitlement comparator 320 may receive an indication of a respective group of users associated with the role from the database 250. Each user in the respective group of users may be identified by an account ID for example. The indication of the respective group of users may be received from the database 250.

In one non-limiting embodiment, the entitlement comparator 320 may retrieve, for each user of the respective group of users, a respective list of user entitlements 254 from the database 250.

The entitlement comparator 320 is configured for comparing, for each user, the list of user entitlements 254 associated with the user to the list of role entitlements 258 associated with the role 256.

It should be noted that manner in which the entitlement comparator 320 compares the respective list of user entitlements 254 and the respective list of role entitlements 258 is not limited. It is contemplated that the entitlement comparator 320 may execute comparison of the list of user entitlements 254 and the list of role entitlements 258 in a sequential manner, and/or in a parallel manner.

In one non-limiting embodiments of the present technology, the entitlement comparator 320 may compare a number entitlements in the list of user entitlements 254 and a number of entitlement in the list of role entitlements 258, and in response to the numbers of entitlements not being equal, the comparison unit may start comparing the entitlements. In some non-limiting embodiments of the present technology, the entitlement comparator 320 may be configured to transmit a signal in response to a number of different entitlements (i.e. difference between the list of user entitlements and the list of role entitlements) being above a predetermined threshold. Additionally or alternatively, the entitlement comparator 320 may transmit a signal in response only to a list of user entitlements 254 having one or more entitlements of a list of predetermined suspect entitlements (not depicted) that are not present in the list of role entitlements 258.

In response to determining that the list of user entitlements 254 corresponds to the list of role entitlements, the entitlement comparator 320 may transmit a signal indicative of a perfect match to the report generator 340.

In response to determining that the list of user entitlements 254 comprises at least one excess entitlement that not included in the list of role entitlements 258, the entitlement comparator 320 transmit an identification of the user along with the suspect entitlements to the report generator 340. In one non-limiting embodiment, the entitlement comparator 320 may retrieve the identification of the user having the excess entitlement from the database 250 or any other database for example.

The report generator 340 is configured to receive a signal from the entitlement comparator 320 after comparison. In some non-limiting embodiments of the present technology, the report generator 340 may be executed by the first server 240.

The report generator 340 may receive a signal indicative of a perfect match from the entitlement comparator 320. In this case, the report generator 340 may be configured for generating and outputting a report indicative of a perfect match between the respective list of user entitlements 254 and the respective list of role entitlements 258. Alternatively, no report may be generated by the report generator 340.

The report generator 340 my receive a signal indicative of excess entitlements, along with an identification of the user. The report generator 340 then generates and outputs a report comprising at least the identification of each user for which at least one excess or suspect entitlement has been identified. In one non-limiting embodiment, the report generator 340 is further configured for inserting in the report a list of the identified excess entitlements associated with each identified user, which may be potentially suspect.

In one non-limiting embodiment, the IAM controller 300 further comprises a usage data analyzer 380 configured for receiving and analyzing usage data for the one or more electronic resources 245 used by the users having excess entitlement(s). In this case, the usage data analyzer 380 may be configured for determining the actions related to the excess entitlement(s) that were performed by the given user. For each excess entitlement, the list of actions performed by a given user is identified using the access usage data 250 of the given user. In one non-limiting embodiment, the usage data analyzer 380 may acquire access usage data from the database 250. In some non-limiting embodiments of the present technology, the

For example, the access usage data 250 accumulated over a predefined period of time may be analyzed by the usage data analyzer 380 to determine the actions related to the suspect entitlement performed during the predefined period of time.

In one non-limiting embodiment, the usage data analyzer 380 may be configured for determining the usage frequency of each suspect entitlement and include the usage frequency in the report. In one non-limiting embodiment, the usage data analyzer 380 may be configured for determining the number of times that a given identified action has been performed. In another embodiment, the usage data analyzer 380 may be configured for determining the dates and times at which each identified action has been performed.

The list of performed actions is then transmitted to the report generator 340 and included in the report along with the corresponding suspect entitlement.

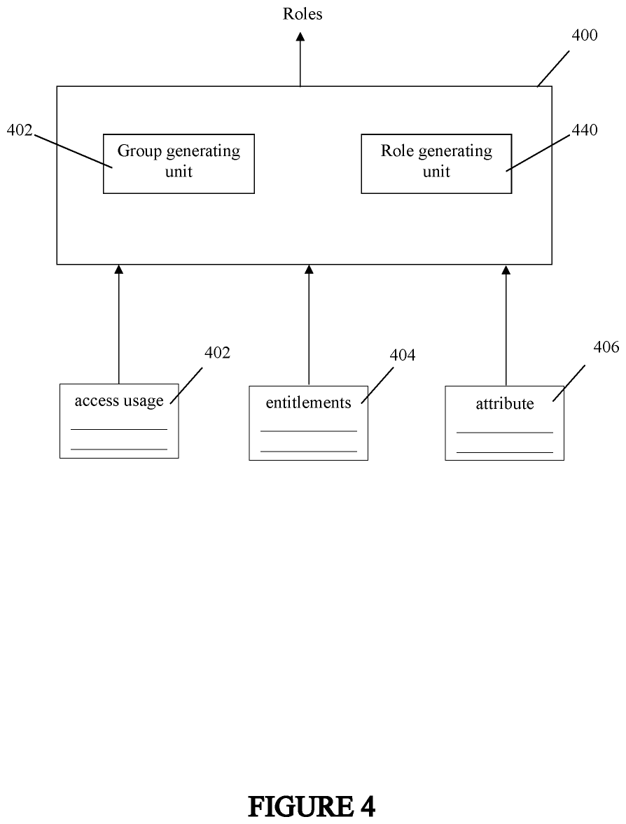

With reference to FIG. 4, there is depicted a schematic diagram of a first role generator for creating roles for an IAM system in accordance with non-limiting embodiments of the present technology.

First Role Generator

The first role generator 400 is executed by the IAM server 270. It should be noted that the second role generator 400 may be executed by another server, such as the first server 240 for example, by more than one server (not depicted) and/or executed in a distributed manner.

The first role generator 400 is configured to generate roles for users of the one or more electronic resources 245.

The first role generator 400 comprises a group generating unit 420 and a role generation unit 440.

The group generating unit 420 is configured for receiving access usage data 402 comprising identities and respective performed actions, and generating a plurality of groups of actions, based on the access usage data 402, by regrouping the identities having associated thereto the same performed actions, where the access usage data 402 includes actions executed by users on the one or more electronic resources 245 via the one or more applications 225 on their respective plurality of client devices 210, as described above.

The role generating unit 440 is configured for receiving from the database 250 a list of entitlements 404 each allowing the actual execution of at least one respective action and determining a group of entitlements contained in the list of entitlements 404 that allow the execution of the group of actions generated by the group generating unit 420.

The role generating unit 440 is further configured for associating a respective group of entitlements to each group of actions in order to generate the roles, and outputting the roles.

In one non-limiting embodiment, the role generating unit 440 is further configured for generating a map of entitlements by mapping the entitlements to the actions using the access usage data and the application data.

In one non-limiting embodiment, the role generating unit 440 is configured for mapping the entitlements to the performed actions by solving a linear program in binary variables.

In one non-limiting embodiment, attribute data 406 comprising HR and/or business attributes from may be received from the database 250.

In one non-limiting embodiment, the group generating unit 420 is configured for generating the plurality of groups of actions further using the attribute data 406.

It should be understood that the group generating unit 420 may use any of the above-described methods for generating the groups of actions.

In one non-limiting embodiment, the role generating unit 440 is further configured for assigning at least one human resources and/or business attribute to each role.

In one embodiment, the data is acquired from the database 250. It should be understood that the different data may be collected via different ways, from different electronic devices and/or databases. For example, access usage data can take the form of logs, diaries, databases, event stores, spreadsheets, APIs, etc. Privilege collections may be provided through APIs, spreadsheets, application documentation, etc. Attribute data may be provided through data files, databases, rolodexes, address books, contact stores, spreadsheets, etc.

It should be understood that any combination of methods for generating the groups of actions may be used. When multiple methods are used, the results are computed from all of the used methods in parallel, and then reconciled for unicity.

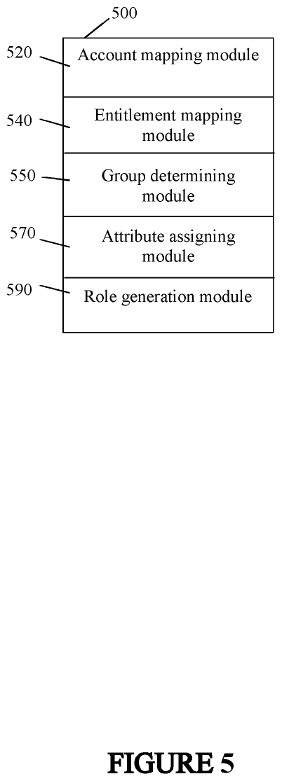

With reference to FIG. 5, there is depicted a schematic diagram of a second role generator for creating roles for an IAM system in accordance with non-limiting embodiments of the present technology.

The second role generator 500 is executed by the IAM server 270. It should be noted that the second role generator 500 may be executed by another server, such as the first server 240 for example, by more than one server (not depicted) and/or executed in a distributed manner.

Generally speaking, the second role generator 500 is configured to generate roles for users of the one or more electronic resources 245 based on inter alia usage access data, application data, and user attribute data.

The second role generator 500 comprises an account mapping module 520, an entitlement mapping module 540, a group determining module 550, an attribute assigning module 570, and a role generation module 590.

The account mapping module 520 is configured to map account IDs to users.

The account mapping module 520 receives, from the database 250, the user attribute data.

In one non-limiting embodiment, the user entity such as the name or the employee number of the users is first retrieved from the attribute data. The user provided identities allow overwriting any discrepancy in the attribute data or the access usage data 260. The unique user accounts are gathered across all of the one or more electronic resources 245. If possible, the application accounts are extracted from the attribute data. The one or more electronic resources 245 and/or the database 250 is queried for identities of yet unmapped accounts (e.g., through API) and fuzzy matching of returned identities on the attribute data is performed. Fuzzy matching in attribute data of remaining accounts may then be performed. Unmapped accounts, if any, may be saved and/or displayed to be manually entered

In one non-limiting embodiment, the account mapping module 520 may access the database 250 to retrieve the mapping of the account IDS to the users. Additionally or alternatively, the account mapping module 520 may perform the mapping by accessing IAM systems, applications such as remote API, Remote procedure call (RPC), or the like.

In one non-limiting embodiment, the account mapping module 520 may store results of the mapping in the database 250 for subsequent use.

The entitlement mapping module 540 is configured to map entitlements to access usage data 260.

The entitlement mapping module 540 receives, from the database 250, the access usage data 260, and the application data.

The entitlement mapping module 540 is configured to map entitlements to actions by the resolution of a linear program over binary variables. A methodology to map as many pairs of which entitlements allow which actions contained in the access usage data 260 may be performed.

In one non-limiting embodiment, the entitlement mapping module 540 may be configured to map actions by determining a minimal-cost set of entitlements p* that enables all actions of given a. Considering that binary vectors of {0, 1}n are embedded in [symbol] ^{m}, p* may be expressed as

$${p}^{*} = arg {min}_{p ∈ {\{ 0 , 1 \}}^{m}} {c}^{t} p$$

$$subject to {P}^{t} p \geq a$$

where:
α∈{0, 1}ⁿ is a binary vector that selects a subset of actions out of a set of n possible actions with aᵢ=1 if and only if the action i is enabled and aᵢ=0 otherwise;
p∈{0, 1}^{m} is a binary vector that selects a subset of entitlements out of a set of m possible entitlements with pⱼ=1 if and only if entitlement j is selected and pⱼ=0 otherwise;
P∈{0, 1}_{m×n}, is a binary matrix mapping entitlements to enabled actions with Pᵢⱼ=1 if and only if the entitlement i enables the action j, and Pᵢⱼ=0 otherwise; and
c∈ [symbol] ^{m} is a vector that sets the cost of granting each entitlement.

In one non-limiting embodiment, if actions have not automatically been mapped to entitlements, a person such as a manager of the IAM system may manually map the remaining actions to entitlements.

The group determining module 550 is configured to regroup users as a function of common performed actions.

The group determining module 550 groups users having performed the same actions, thereby obtaining groups of users and a respective group of performed actions for each group of users.

In one non-limiting embodiment, the group determining module 550 may access the one or more MLAs 275 executed by the IAM server 270 for the determination of the group of actions.

The group determining module 550 may input, in the one or more MLAs 275, the usage access data and optionally the attribute data. In one non-limiting embodiment, a clustering method, a matrix decomposition method, a topic modeling and/or a frequent itemset method may be used for regrouping actions.

Non-limiting examples of clustering methods include the DBSCAN method, the K-Means method, the Hierarchical clustering method, and the like. Non-limiting example of topic modeling methods include the Latent Dirichlet Allocation (LDA) method, the Hierarchical Dirichlet Process (HDP) method, and the like. A non-limiting example of the frequent itemset method comprises the apriori method. The output of these methods comprises groups of actions, i.e. a group-action assignment, and optionally a group-attribute assignment in the event that attribute data was provided as input.

In one non-limiting embodiment, the group-action assignment previously performed may be considered as an identification of candidate actions to groups and the candidate actions have to be confirmed. In this case, the group determining module 550 determines whether the candidate action should be assigned to the group. Depending on how the group of candidate actions is generated, the assignment of actions may be done by direct assignment, or by using a discretization procedure to convert the probabilistic assignment to a binary group-action assignment. The output is a confirmed group-action assignment, i.e. groups of users and a respective group of actions associated to each group of users.

The role generation module 590 is configured to generate roles and output the roles.

The role generation module 590 receives as an input the groups of actions determined by the group determining module 550 and the respective entitlements that allow the actions determined by the entitlement mapping module 540

The attribute assigning module 570 is configured to assign respective HR and/or business attributes to the groups of users.

The attribute assigning module 570 assigns respective HR and/or business attributes to each role determined by the role generation module 590.

This may be done by using the group-attribute assignment determined by the group determining module 550 or by using a predefined heuristic and/or machine learning algorithm. Examples of algorithms include frequent itemset methods, or the like. The input of the algorithm comprises the attribute data and the group-action assignment determined by the group determining module 550 and the output is a group-attribute assignment, i.e. a group of HR and/or business attributes associated to each role. For each user, it is determined by their respective HR and/or business attributes values that are associated with the role if they are assigned or not to the role. In one non-limiting embodiment, the group of HR and/or business attributes may be received from the database 250.

The attribute assigning module 570 then outputs the generated roles.

As a non-limiting example, the generated roles may be displayed to an IAM analyst for approval. In one non-limiting embodiment, a generated role may be displayed along with at least some of the following information:
an identification of the persons who should be included in the role;
the privileges that should be included in the role;
an identification of the new entitlements that were not assigned to the members of the group before the generation of the role; and/or
an evaluation of how much of the accesses of the members of the group are covered by the role

The IAM analyst is then asked to confirm the displayed role and may also modify the role. The IAM analyst may also input a name and/or a description for the role.

In order to help for the maintenance, the generated roles may be visible in the one or more electronic resources 245 or the IAM system and a notification may be sent to the IAM analyst when a role is removed.

In one non-limiting embodiment, when the IAM server 270 determines that the attribute data and/or access usage data 260 has changed such as when new accesses are used, some accesses become unused or organization units have changed, a notification indicative of the change may be sent to the IAM analyst. The notification may also include proposed changes to the role in order to maintain the role coverage. In one non-limiting embodiment, the IAM server 270 may execute the above mentioned procedures when changes are above a predetermined threshold of changes.

As mentioned above, the above-described method, system and processing module may further perform the generation of a role in an IAM system. It should be understood that any adequate method for generating a role in an IAM system and determining its associated group of users may be used. It should also be understood that several methods may be combined together for generating a role.

Method Description

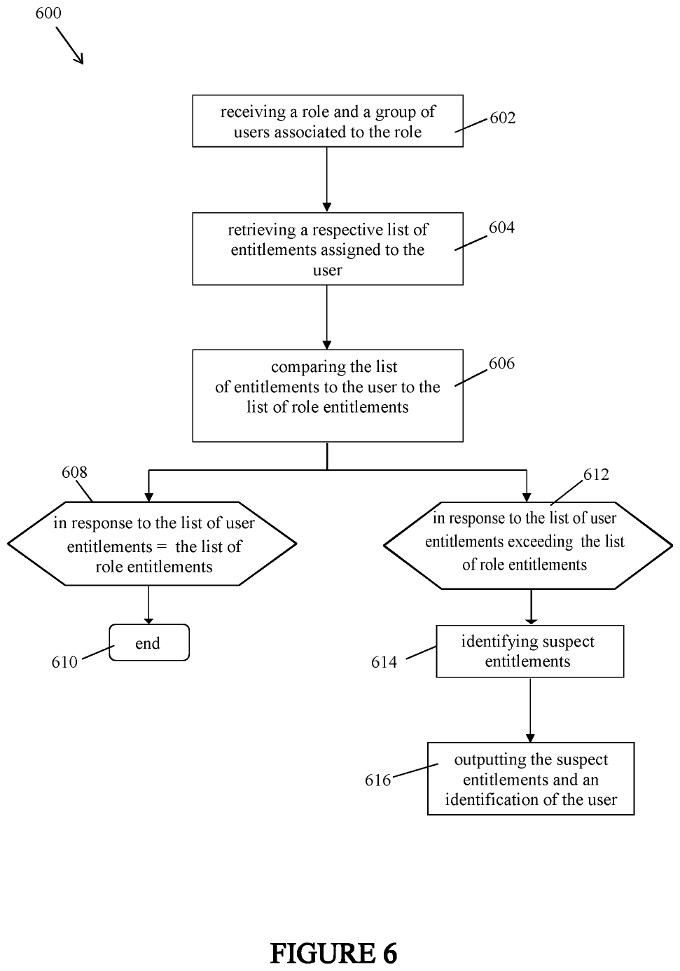

FIG. 6 illustrates a computer-implemented method 600 for identifying users who may be provided with excess entitlements in accordance with non-limiting embodiments of the present technology.

The method 600 is executed by the IAM server 270. In some embodiments, the method 600 may be executed by more than one server.

As a non-limiting example, in embodiments where the IAM server 270 is implemented as the electronic device 100 of FIG. 1, the processor 110 the IAM server 270 may have access to computer-readable instruction stored in a memory (such as the solid-state drive 120, or the random access memory 130) having stored, which upon being executed by the processor 110, cause the processor to execute the method 600.

The method 600 begins at step 602.

Step 602: Receiving a Role, the Role Including Role Entitlements

At step 602, the processor 110 receives, from the database 250, a role 256, the role 256 including a list of role entitlements 258.

The role includes a list of entitlements, hereinafter referred to as role entitlements, and a group of users is associated with the role. The users included in the group are all assigned the entitlements associated with the role. At step 602, an identification of the users who are part to the group associated with the role is also received.

The method 600 advances to step 604.

Step 604: Receiving a List of User Entitlements

At step 604, the processor 110 receives, from the database 250, for each user of the group associated with the role, the respective entitlements (hereinafter referred to as user entitlements) are received. It should be understood that the role entitlements and the user entitlements may be stored in the IAM system. In this case, the role entitlements and the user entitlements are retrieved from the IAM system.

The method 600 advances to step 606.

Step 606: Comparing the Role Entitlements with the List of User Entitlements

At step 606, the processor 110 compares, for each user of the group of users, the list of user entitlements 254 to the list of role entitlements 258.

The method 600 advances to step 608.

Step 608: In Response to the Respective List of User Entitlements Associated with a Given User of the at Least Portion of the Group of Users Exceeding the List of Role Entitlements:
retrieving an identification of the given user.

If for a given user, the processor 110 determines that the list of user entitlements 254 exactly corresponds to the list of role entitlements 258 (step 608), i.e. each entitlement contained in the list of user entitlements 254 is also contained in the list of role entitlements 258 and each entitlement contained in the list of role entitlements 258 is contained in the list of user entitlements 254, then the user is considered as having the entitlements that he is supposed to have and as having no unnecessary entitlement, and the method is stopped at step 600.

If for a given user, the processor 110 determines that the list of user entitlements 254 is greater than the list of role entitlements 258 (step 602), i.e. if the list of user entitlements 254 includes at least one entitlement that is not included in the list of role entitlements 258 assigned to the given user, then it is determined that the given user is provided with at least one suspect entitlement. In this case, the suspect entitlement(s) is(are) identified at step 604, i.e. the entitlement(s) included in the list of user entitlements 254 but not included in the list of role entitlements 258, is(are) identified.

An identification (ID) of the given user and the identified unnecessary entitlement(s) are outputted at step 606. In one non-limiting embodiment, the ID of the given user and his/her associated suspect entitlement(s) are stored in memory. In the same or another embodiment, the he ID of the given user and his/her associated suspect entitlement(s) are displayed on a display.

In this case, a person such as a manager is informed that the given user may have been assigned at least one entitlement which should potentially not have been assigned to the given user. The manager may then determine if the given user should keep identified entitlement(s) or if the identified entitlement(s) should be removed from the list of entitlements assigned to the given user.

In an embodiment in which for a given user, it is determined that the list of user entitlements 254 contains at least one suspect entitlement that is not included in the list of role entitlements 258, the method 600 further comprises a step of determining the actions related to the suspect entitlement(s) that were performed by the given user. For each suspect entitlement, the list of actions performed by the given user is identified using the access usage data 260 of the given user. For example, the access usage data 260 accumulated over a predefined period of time may be analyzed to determine the actions related to the suspect entitlement performed during the predefined period of time. The list of performed actions is then outputted along with the corresponding suspect entitlement at step 606.

In one non-limiting embodiment, the usage frequency of the suspect entitlement may also be determined and outputted at step 606. In one non-limiting embodiment, the number of times that a given identified action has been performed may be determined and outputted at step X26. In another embodiment, the dates and times at which each identified action has been performed is identified and outputted at step 606.

In one non-limiting embodiment, the method 600 further comprises a step of generating the role and identifying the group of users associated with the role.

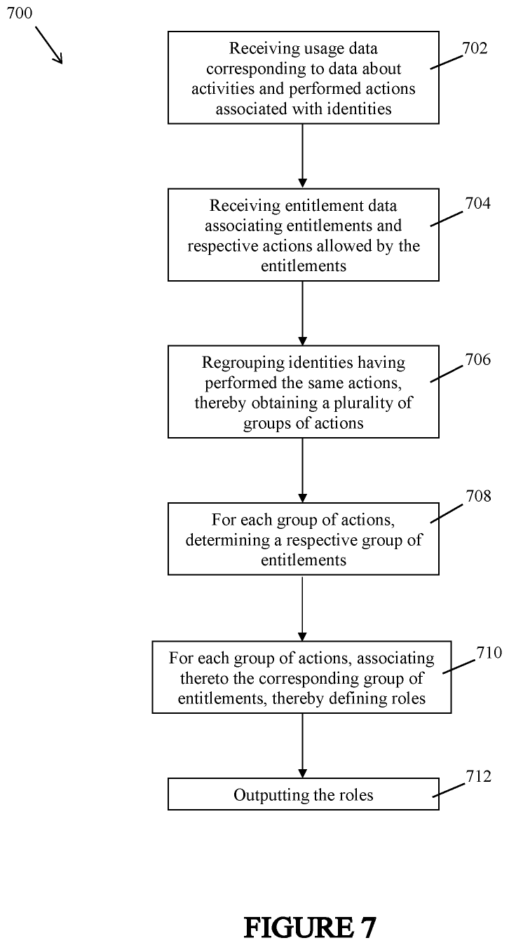

FIG. 7 illustrates a computer-implemented method 700 for defining roles in an IAM system in accordance with non-limiting embodiments of the present technology.

The method 700 is executed by the IAM server 270.

As a non-limiting example, in embodiments where the IAM server 270 is implemented as the electronic device 100 of FIG. 1, the processor 110 the IAM server 270 may have access to a memory (such as the solid-state drive 120, or the random access memory 130) having computer-readable instructions stored therein, which upon being executed by the processor 110, cause the processor to execute the method 700.

The method 700 begins at step 702.

Step 702: Receiving Access Usage Data

At step 702, the processor 110 receives, from the database 250, access usage data 260 for at least a portion of the users. Each user is identified by a respective user ID. The access usage data 260 describe all activities and actions performed by each identity over a given period of time. In one non-limiting embodiment, the access usage data 260 comprise data about any application, system or site that a user may access.

The method 700 advances to step 704.

Step 704: Receiving Entitlement Data

At step 704, the processor 110 receives, from the database 250, entitlement data. The entitlements data comprises a list of entitlements and actions allowed by the entitlements. In one non-limiting embodiment, an entitlement allows at least one action to be performed. In the same or another embodiment, more than one entitlement may be required to a performed a single action.

In one non-limiting embodiment, the list of entitlements received at step 704 comprises all possible entitlements created for any application, system or site that a user may access.

In one non-limiting embodiment and as described below, the step 704 consists in generating the list of entitlements and respective actions.

The method 700 advances to step 706.

Step 706: Analyzing the Access Usage Data

At step 706, the processor 110 analyzes the access usage data 260 received at step 702 to regroup together the identities having performed the same actions. As a result, groups of identities are created and a respective group of same actions is associated with each group of entities to obtain a plurality of groups of actions. Each thus obtained group of actions may be seen as the first component of a respective role.

The method 700 advances to step 708.

Step 708: Associating Group of Actions to Group of Entitlements

At step 708, the processor 110 associates a corresponding group of entitlements to each group of actions determined at step 706, using the list of entitlements. Knowing the actions allowed by a given entitlement, a group of entitlements is generated by retrieving the given entitlements that allow the execution of the all of the actions contained in a group of actions. Each thus obtained group of entitlements may be seen as the second component of a respective role.

The method 700 advances to step 710.

Step 710: Generating Roles At step 710, the processor 110 generates roles by associating the respective group of entitlements determined at step 708 to each group of actions determined at step 706.

The method 700 advances to step 712.

Step 712: Outputting the Roles

At step 712, the processor 110 outputs the roles generated at step 710. In one non-limiting embodiment, the roles are stored in memory. In the same or another embodiment, the roles may be transmitted to another computer machine such as an IAM system.

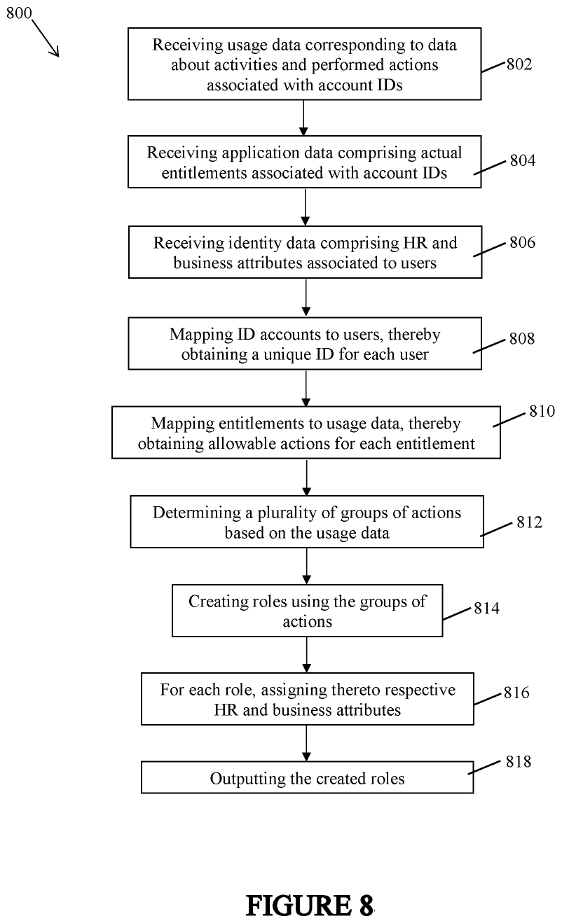

FIG. 8 illustrates a further embodiment of a computer-implemented method 800 for creating roles for an IAM system in accordance with non-limiting embodiments of the present technology.

The method 800 is executed by the IAM server 270.

As a non-limiting example, in embodiments where the IAM server 270 is implemented as the electronic device 100 of FIG. 1, the processor 110 the IAM server 270 may have access to a memory (such as the solid-state drive 120, or the random access memory 130) having computer-readable instructions stored therein, which upon being executed by the processor 110, cause the processor to execute the method 800.

The method 800 begins at step 802.

Step 802: Receiving Access Usage Data

At step 802, the processor 110 receives, from the database 250, access usage data 260. The access usage data 260 comprises a plurality of accounts identifications (IDs) and all activities and actions performed by each account ID while using any application, system or site that a user may use. In one non-limiting embodiment, a user is provided with a single account ID. In another embodiment, more than one account ID may be assigned to a same user.

Adequate sources for collecting the access usage data 260 may comprise SIEM systems, directories, applications, and/or the like.

In one non-limiting embodiment, the access usage data 260 may comprise authentication and authorization activity to an application, audit logs of activities or actions within an application, and/or the like.

The method 800 advances to step 804.

Step 804: Receiving Application Data

At step 804, the processor 110 receives, from the database 250, application data. The application data comprises actual entitlements associated to account IDs. It should be understood that the entitlements actually assigned to a given account ID may be inaccurate. For example, some of the entitlements assigned to a given account ID may provide access to the user of the account ID to applications that he does not need or he does not use or to applications that he should not be allowed to access.

In one non-limiting embodiment, the application data may be collected by connecting to IAM systems, directories and/or applications.

The method 800 advances to step 806.

Step 806: Receiving Attribute Data

At step 806, the processor 110 receives, from the database 250, attribute data. For each user, the attribute data comprises respective attributes such as HR attributes and/or business attributes that may help identify a user's function within an organization. For example, the attribute data may comprise a title, a level, a manager's ID, an organization unit, a status, and/or the like.

In one non-limiting embodiment, the attribute data is collected via systems such as IAM systems, HR systems, and/or the like.

The method 800 advances to step 808.

Step 808: Mapping Accounts to Users

At step 808, the processor 110 maps the account IDs are to the users. For each user, at least one respective account ID is determined. When more than one account ID is associated to same user, the mapping of the account IDs to the users allows regrouping into a single user ID all of the account IDs associated to the user, and therefore all of the usage data associated to the user under different account IDs.

In one non-limiting embodiment, the mapping of the account IDs to the users may be performed by accessing IAM systems, applications such as remote API, Remote procedure call (RPC), or the like.

In one non-limiting embodiment, the user entity such as the name or the employee number of the users is first retrieved from the attribute data received at step 806. The user provided identities allow overwriting any discrepancy in the attribute data or the access usage data 260. The unique user accounts are gathered across all of the one or more resources 245 accessible via the one or more applications 220. If possible, the application accounts are extracted from the attribute data.

The one or more resources 245 and/or the database 250 are queried for identities of yet unmapped accounts (e.g., through API) and fuzzy matching of returned identities on the attribute data is performed. Fuzzy matching in attribute data of remaining accounts may then be performed. Unmapped accounts, if any, may be saved and/or displayed to be manually entered.

The method 800 advances to step 810.

Step 810: Mapping Entitlements Based on the Access Usage Data and the Application Data

At step 810, the processor 110 maps entitlements to the all possible performed actions received at step 802 using the access usage data 260 and the application data. At step 160, it is determined the relationship between entitlements and performed actions, i.e. which respective entitlement(s) allows the execution of each performed action contained in the access usage data 260.

In one non-limiting embodiment, the mapping of entitlements to actions is done by the resolution of a linear program over binary variables. A methodology to map as many pairs of which entitlements allow which actions contained in the access usage data 260 may be performed.

In one non-limiting embodiment, the mapping of the entitlements to actions is performed using the following method. The minimal-cost set of entitlements p* that enables all actions of given a is determined. Considering that binary vectors of {0, 1}n are embedded in [symbol] , p* may be expressed as

$${p}^{*} = arg {min}_{p ∈ {\{ 0 , 1 \}}^{m}} {c}^{t} p$$

$$subject to {P}^{t} p \geq a$$

where:
α∈{0, 1}ⁿ is a binary vector that selects a subset of actions out of a set of n possible actions with aᵢ=1 if and only if the action i is enabled and aᵢ=0 otherwise;
p∈{0, 1}^{m} is a binary vector that selects a subset of entitlements out of a set of m possible entitlements with pᵢ=1 if and only if entitlement j is selected and pᵢ=0 otherwise;
P∈{0, 1}_{m×n}, is a binary matrix mapping entitlements to enabled actions with Pᵢⱼ=1 if and only if the entitlement i enables the action j, and Pᵢⱼ=0 otherwise; and
c∈ [symbol] ^{m} is a vector that sets the cost of granting each entitlement.

In one non-limiting embodiment, if actions have not automatically been mapped to entitlements, a person such as a manager of the IAM system may manually map the remaining actions to entitlements.

The method 800 advances to step 812.

Step 812: Grouping Actions to Users

At step 812, the processor 110 executes grouping of the actions of users. Users having performed the same actions are regrouped, thereby obtaining groups of users and a respective group of performed actions for each group of users.

In one non-limiting embodiment, the determination of the groups of actions may be performed using a predefined machine learning algorithm using the usage access data 260 and optionally the attribute data. In one non-limiting embodiment, a clustering method, a matrix decomposition method, a topic modeling and/or a frequent itemset method may be used for regrouping actions. The input of these methods comprise the access usage data 260 and optionally the attribute data. Examples of clustering methods include the DB SCAN method, the K-Means method, the Hierarchical clustering method, and the like. Examples of topic modeling methods include the Latent Dirichlet Allocation (LDA) method, the Hierarchical Dirichlet Process (HDP) method, and the like. An example of the frequent itemset method comprises the apriori method. The output of these methods comprises groups of actions, i.e. a group-action assignment, and optionally a group-attribute assignment in the event that attribute data was provided as input.

In one non-limiting embodiment, the group-action assignment previously performed may be considered as an identification of candidate actions to groups and the candidate actions have to be confirmed. In this case, the method 800 further comprises a step of determining whether the candidate action should be assigned to the group. Depending on the output of the method used for generating groups of candidate actions, the assignment of actions may be done by direct assignment, or by using a discretization procedure to convert the probabilistic assignment to a binary group-action assignment. The output is a confirmed group-action assignment, i.e. groups of users and a respective group of actions associated to each group of users.

The method 800 advances to step 814.

Step 814: Generating Roles

At step 814, the processor 110 generates the roles using the groups of actions determined at step 812 and the respective entitlements that allow the actions at step 810.

Step 816: Assigning Attributes

At step 816, the processor 110 assigns respective HR and/or business attributes to each role determined at step 814. This may be done by using the group-attribute assignment determined in step 812, if outputted, or by using a predefined heuristic and/or machine learning algorithm. Examples of algorithms include frequent itemset methods, or the like. The input of the algorithm comprises the attribute data and the group-action assignment determined at step 812. And the output is a group-attribute assignment, i.e. a group of HR and/or business attributes associated to each role. For each user, it is determined by their respective HR and/or business attributes values that are associated with the role if they are assigned or not to the role.

It should be understood that the step 816 may be omitted.

The method 800 advances to step 818.

Step 818: Outputting the Roles

At step 818, the processor 110 outputs the generated roles. In one non-limiting embodiment, the roles may be stored in memory. In the same or another embodiment, the generated roles may be displayed on a display unit for approval for example.

In one non-limiting embodiment, the generated roles may be displayed to an IAM analyst for example for approval. In one non-limiting embodiment, a generated role may be displayed along with at least some of the following information:
an identification of the persons who should be included in the role;
the privileges that should be included in the role;
an identification of the new entitlements that were not assigned to the members of the group before the generation of the role; and/or
an evaluation of how much of the accesses of the members of the group are covered by the role

The IAM analyst is then asked to confirm the displayed role and may also modify the role. The IAM analyst may also input a name and/or a description for the role.

In order to help for the maintenance, the generated roles may be visible in the one or more electronic resources 245 or the IAM system and a notification may be sent to the IAM analyst when a role is removed.

In one non-limiting embodiment, when the system determines that the attribute data and/or access usage data 260 has changed such as when new accesses are used, some accesses become unused or organization units have changed, a notification indicative of the change may be sent to the IAM analyst. The notification may also include proposed changes to the role in order to maintain the role coverage.

It is contemplated that steps the methods 600, 700, and 800 may be combined and executed without departing the scope of the present technology. In one non-limiting embodiment, the methods may be executed to continuously improve identity and access management in the one or more electronic resources 245.

In one non-limiting embodiment, the present method and system allow reducing the effort of finding patterns roles and accelerating the return on investment by adding data not prone to the noise of access rights, namely the actual access usage data 260. The present method and system allow for mapping access usage detail to access right automatically through the pattern itself with least common denominator access. The data volume for actual access usage (which is generated at every action) is important compared to access rights, which is semi-static. Therefore, more accurate results may be obtained. The present method and system allow automating many of the mathematical variables in role mining, thereby reducing the expertise required for IAM managers for example. In one non-limiting embodiment, human error may be mitigated in access granting since the actual aces data are used for defining the roles, the present method and system offer a better picture of the entitlements associated with roles. Furthermore, maintenance of roles may be facilitated by automatically proposing changes to existing roles when access usage evolves far enough from the base role norm.

It should be understood that any combination of methods for generating the groups of actions may be used. When multiple methods are used, the results are computed from all of the used methods in parallel, and then reconciled for unicity.

It should be apparent to persons skilled in the art there is a need to reduce the amount of entitlements to those that are out of the norm of similar users, and give more context on the usage of the entitlements so that informed decision may be made to attest the entitlements.

In some instances, embodiments of the present technology may allow reducing usage of resources on the server by reducing the amount of entitlements and limiting access rights to unauthorized users, which may in turn save computational resources.

In some instances, entitlements and actions of users, including excess entitlements, could be analyzed and used to generate roles, which may also save computational resources and improve security in a computer system.

The embodiments of the invention described above are intended to be exemplary only. The scope of the invention is therefore intended to be limited solely by the scope of the appended claims.

1. A computer-implemented method for access verification in an identity and access management (IAM) system, the method being executable by a server, the method comprising:
receiving a role and a group of users associated with the role, the role comprising a list of role entitlements, the list of role entitlements being indicative of given permissions to execute first actions in at least one electronic resource by each user of the group of users;
for each one of the at least a portion of the group of users, retrieving a respective list of user entitlements, the list of user entitlements being indicative of actual permissions to execute second actions in the at least one electronic resource, the actual permissions having been granted to a respective user;
for each one of the at least portion of the group of users, comparing the respective list of user entitlements to the list of role entitlements; and
retrieving and outputting an identification of a given user of the at least portion of the group of users in response to the respective list of user entitlements exceeding the list of role entitlements for the given user:

2. The computer-implemented method of claim 1, wherein the respective list of user entitlements associated with the given user exceeding the list of role entitlements is indicative of at least one potential excess user entitlement, the computer-implemented method further comprising:
retrieving, based on the identification of the given user, usage data for the given user, the usage data being indicative of actions having been executed by the given user;
determining, based on the potential excess user entitlement, excess actions executed by the given user in the usage data while using the potential excess user entitlement; and
outputting the determined excess actions.

3. (canceled)

4. The computer-implemented method of further comprising generating the role and determining the group of users associated with the role, said generating the role is performed using at least one of top-down role mining method, a by-example method, a visual-based method and a bottom-up role mining method.

5. (canceled)

6. The computer-implemented method of claim 4, wherein the bottom-up role mining method comprises:
receiving access usage data comprising identities and respective performed actions;
receiving a list of access entitlements each allowing the execution of at least one respective action;
generating a plurality of groups of actions by regrouping given ones of the identities having associated thereto a same group of the respective performed actions using the access usage data;
for each one of the plurality of groups of actions, determining a group of entitlements contained in the list of access entitlements that allow the execution of the group of actions;
for each one of the plurality of groups of actions, associating thereto the respective group of entitlements, thereby obtaining a plurality of roles; and
outputting the plurality of roles.

7. The computer-implemented method of claim 6, wherein said receiving access usage data comprises receiving an account identification (ID) for the given user and the excess actions.

8. The computer-implemented method of claim 7, further comprising receiving application data comprising actual entitlements associated with the account ID.

9. The computer-implemented method of claim 8, wherein said receiving the list of access entitlements comprises generating a map of entitlements by mapping the access entitlements to the performed actions using the access usage data and the application data.

10. (canceled)

11. The computer-implemented method of claim 9, further comprising receiving attribute data comprising the user ID and human resources and business attributes.

12. (canceled)

13. (canceled)

14. The computer-implemented method of claim 11, wherein said generating the plurality of groups of actions is performed using at least one of a clustering method, a matrix decomposition method, a topic modeling method and a frequent itemset method to obtain a probabilistic assignment of actions to the groups of actions.

15. (canceled)

16. (canceled)

17. (canceled)

18. The computer-implemented method of claim 14, further comprising using a discretization procedure to convert the probabilistic assignment of actions to the groups of actions to an actual assignment of actions to the groups of actions.

19. (canceled)

20. (canceled)

21. (canceled)

22. (canceled)

23. A server for access verification in an Identity and Access Management (IAM) system, the server comprising:
a processor;
communication means for at least one of receiving and transmitting data; and
a memory operatively connected to the processor, the memory comprising computer-readable instructions stored thereon;
the processor, upon execution of the computer-readable instructions, being configured for:
receiving a role and a group of users associated with the role, the role comprising a list of role entitlements, the list of role entitlements being indicative of given permissions to execute first actions in at least one electronic resource by each user of the group of users;
for each one of the at least a portion of the group of users, retrieving a respective list of user entitlements, the list of user entitlements being indicative of actual permissions to execute second actions in the at least one electronic resource, the actual permissions having been granted to a respective user;
for each one of the at least portion of the group of users, comparing the respective list of user entitlements to the list of role entitlements; and
retrieving and outputting an identification of a given user of the at least portion of the group of users in response to the respective list of user entitlements exceeding the list of role entitlements for the given user:

24. The server of claim 23, wherein the respective list of user entitlements associated with the given user exceeding the list of role entitlements is indicative of at least one potential excess entitlement, and the processor is further configured for:
retrieving, based on the identification of the given user, usage data for the given user, the usage data being indicative of actions having been executed by the given user;
determining, based on the potential excess user entitlement, excess actions executed by the given user in the usage data while using the potential excess user entitlement; and
outputting, the determined excess actions.

25. (canceled)

26. The system of claim 23, wherein the processor is further configured for generating the role and determining the group of users associated with the role, said generating the role is performed using at least one of top-down role mining method, a by-example method, a visual-based method and a bottom-up role mining method.

27. (canceled)

28. The server of claim 26, wherein the processor is configured for using the bottom-up role mining technique, the processor being configured for:
receiving access usage data comprising identities and respective performed actions;
receiving a list of access entitlements each allowing the execution of at least one respective action;
generating a plurality of groups of actions by regrouping given ones of the identities having associated thereto a same group of the respective performed actions using the access usage data;
for each one of the plurality of groups of actions, determining a group of entitlements contained in the list of access entitlements that allow the execution of the group of actions;
for each one of the plurality of groups of actions, associating thereto the respective group of entitlements, thereby obtaining a plurality of roles; and
outputting the plurality of roles.

29. The server of claim 28, wherein the access usage data comprises an account identification (ID) for the given user and the excess actions.

30. The server of claim 29, wherein the processor is further configured for receiving application data comprising actual entitlements associated with the account ID.

31. The server of claim 30, wherein the processor is further configured for generating a map of entitlements by mapping the access entitlements to the performed actions using the access usage data and the application data.

32. (canceled)

33. The server of claim 31, wherein the processor is further configured for receiving attribute data comprising the user ID and human resources and business attributes.

34. (canceled)

35. (canceled)

36. The server of claim 33, wherein the processor is further configured for generating the plurality of groups of actions using at least one of a clustering method, a matrix decomposition method, a topic modeling method and a frequent itemset method to obtain a probabilistic assignment of actions to the groups of actions.

37. (canceled)

38. (canceled)

39. (canceled)

40. The server of claim 36, wherein the processor is further configured for using a discretization procedure to convert the probabilistic assignment of actions to the groups of actions to an actual assignment of actions to the groups of actions.

41. (canceled)

42. (canceled)
